(19) United States
(12) Patent Application Publication
(10) Pub. No.: US 2022/0251370 A1
(43) Pub. Date: Aug. 11, 2022

(54) PEO-PPO-PEO TRIBLOCK COPOLYMERS AS ADDITIVES FOR EPOXIDE-ANHYDRIDE SYSTEMS

(71) Applicant: Henkel AG & Co. KGaA, Duesseldorf (DE)

(72) Inventors: Andreas Niegemeier, Langenfeld (DE); Andreas Ferencz, Duesseldorf (DE); Tamara Schmidt, Oberhausen (DE); Mustapha Benomar, Duisburg (DE); Wolfgang Lupp, Duisburg (DE)

(21) Appl. No.: 17/660,948

(22) Filed: Apr. 27, 2022

Related U.S. Application Data
(63) Continuation of application No. PCT/EP2020/082625, filed on Nov. 19, 2020.

(30) Foreign Application Priority Data
Nov. 22, 2019 (EP) 19211026.0

(51) Int. Cl. C08L 63/00

(52) U.S. Cl. CPC C08L 63/00

(57) ABSTRACT

The present invention relates to curable resin compositions, to methods for producing a cured composition using said curable resin compositions, and articles, in particular molded parts, produced by such methods.

The present invention relates to curable resin compositions, to methods for producing a cured composition using such curable resin compositions, and articles, in particular molded parts, produced by such methods.

The lightweight construction of automobiles is becoming increasingly important in the automotive industry, with molded parts made of carbon fiber reinforced plastics material (CFRP) in particular being in increasing demand from the automotive industry. Such molded parts are installed, for example, in the form of rims, which are exposed to high temperatures during braking. Consequently, it is essential to use matrix resins in the production of the corresponding molded parts, which resins have very high glass transition temperatures T_{g} in the cured state, since otherwise a heat-repellent protective lacquer would have to be applied, which would make the production process even more complex. For this reason, matrix resins based on epoxide-anhydride systems are preferably used, since these have high glass transition temperatures in the case of corresponding crosslinking.

In order to increase the impact toughness of the aforementioned systems, flexibilizers or tougheners are usually added to the reactive resin mixtures. However, conventional flexibilizers or tougheners in the form of CTNB (carboxyl terminated butadiene nitrile) or CSR (core-shell rubber) particles lead to lower glass transition temperatures T_{g} of the cured products and also make them appear cloudy and discolored.

U.S. Pat. No. 8,927,677 B2 discloses the use of polyols having high molecular weights (>7,000) as tougheners for curable epoxy resin compositions, which are capable of increasing both the glass transition temperature and the toughness of a correspondingly cured article. Furthermore, the use of various mixed polyethers in the form of multiblock copolymers, for example in the form of di-, tri- or tetrablock copolymers, as tougheners for curable polymeric matrix systems is also known. For example, WO 2016/179063 A1 discloses polyester-based thermoplastic polymer mixtures to which amphiphilic polyalkylene ether-based block copolymers are added to increase the toughness. The possibility of transparent products is also mentioned. EP 2 110 397 A1 discloses the use of impact toughness modifiers which are obtained by reacting amphiphilic block copolymers with isocyanates and which increase the impact strength of cured epoxy resin compositions and at the same time at least do not negatively influence the glass transition temperature. Although commercial PPO-PBO diblock copolymers lead to both transparent and colorless cured products, they do not have a positive effect on either the glass transition temperature or the toughness of the cured products.

There is consequently still a need for epoxy-based resin compositions which produce cured articles which have both a high glass transition temperature (DSC (differential scanning calorimetry) midpoint 200° C.) and toughness (K1c value ≥0.8) and are as transparent and colorless as possible.

The present invention is based on the finding of the inventors that, by using amphiphilic PEO (polyethylene)-PPO (polypropylene)-PEO (polyethylene) triblock copolymers having certain minimum total molar masses and certain mass fractions of EO groups in the overall polymer instead of conventional tougheners in epoxy resin anhydride systems, curable formulations can be obtained which, in the cured state, have high glass transition temperatures and toughness and at the same time have excellent optical properties, i.e. transparency and approximate colorlessness.

The present invention therefore, in a first aspect, relates to a resin composition comprising at least one epoxy resin component and at least one curing component, characterized in that the resin composition further comprises at least one PEO-PPO-PEO triblock copolymer.

Another aspect of the present invention discloses a method for producing a cured composition, comprising the steps of

(1) providing a resin composition as described herein; and
(2) curing the resin composition to obtain a cured composition.

In a further aspect, the present invention relates to a cured composition obtainable by a method as described herein.

“At least one,” as used herein, refers to 1 or more, for example 1, 2, 3, 4, 5, 6, 7, 8, 9 or more. In connection with constituents of the catalyst compositions described herein, this information does not refer to the absolute amount of molecules, but to the type of the constituent. “At least one epoxide” therefore signifies, for example, one or more different epoxides, i.e. one or more different types of epoxides. Together with stated amounts, the stated amounts refer to the total amount of the correspondingly designated type of constituent, as defined above.

“About” or “approximately”, as used herein in connection with numerical values, refers to the referential numerical value ±10%, preferably ±5%.

Unless stated otherwise, the molecular weights indicated in the present text relate to the number-average molecular weight (Mn). The number-average molecular weight can be determined by gel permeation chromatography according to DIN 55672-1:2007-08 with THF as the eluent. Except where indicated otherwise, all molecular weights indicated are those that have been determined by means of GPC.

The viscosity of the liquid composition described herein is in particular low enough for the composition to be pumpable and to be able to wet and impregnate fiber materials, for example, as used for fiber-reinforced plastics parts. In various embodiments, the reaction mixture has a viscosity of <100 mPas at a temperature of 100° C. In order to determine the viscosity, the resin mixture is prepared at room temperature using a suitable mixer and, on a plate/plate rheometer having a diameter of 25 mm, a gap of 0.05 mm and a shear rate of 100 s in rotation, the viscosity is determined with the temperature increasing at a heating rate of 6 K/min.

The present invention relates to resin compositions which comprise at least one epoxy resin component and at least one curing component and are moreover characterized in that they further comprise at least one PEO-PPO-PEO triblock copolymer.

In some embodiments of the present invention, the at least one PEO-PPO-PEO triblock copolymer therefore has a molecular weight of >6,000 and preferably of >12,000. Thus, PEO-PPO-PEO triblock copolymers used according to the invention have, for example and without intending to be understood as restrictive, a total molecular weight of 6,025, 6,050, 6,100, 6,125, 6,150, 6,175, 6,200, 6,250, 6,300, 6,400, 6,500, 7,000, 7,500, 8,000, 9,000, 10,000, 11,000, 12,000, 13,000, 14,000, 15,000, 16,000, 17,000, 18,000, 19,000 or 20,000.

In further embodiments, the PEO-PPO-PEO triblock copolymer used as described herein is characterized by a certain molar mass fraction of the ethylene oxide monomers in the total molar mass of the triblock polymer. In some embodiments, the molar mass fraction of the PEO block polymers is therefore at least 50%. Correspondingly, the molar mass fraction of the PEO block polymers in the PEO-PPO-PEO triblock copolymers can be 50%, 51%, 52%, 53%, 54%, 55%, 60%, 65%, 70%, 75%, 80%, 85%, 90% or 95%. In further embodiments, the molar mass fraction of the PEO block polymers is 50%-90%, preferably 50%-85% and more preferably 50%-80%.

Examples of commercially available, suitable PEO-PPO-PEO triblock copolymers include Pluronic F68, Pluronic PE 6800, Synperonic PE/F68, Pluronic F77, Pluronic F87, Synperonic PE/F87, Pluronic F88, Pluronic F98, Pluronic P105, Pluronic PE 10500, Pluronic F108, Synperonic PE/F108, Pluronic F127 and Synperonic PE/F127.

The resin compositions according to the invention typically contain the PEO-PPO-PEO triblock copolymer as described herein, based on the total weight of the resin composition, in amounts in the range of 5-20 wt. %, preferably in the range of 7-18 wt. % and more preferably in the range of 10-15 wt. %. As described herein, PEO-PPO-PEO triblock copolymers can be used as individual components or in the form of their mixtures.

In principle, the PEO-PPO-PEO triblock copolymers as described herein can be used either as a constituent of the epoxy resin component, as defined below, or as a constituent of the curing component, as defined below. Alternatively, there is also the possibility of using the PEO-PPO-PEO triblock copolymers as described herein as a constituent of the two aforementioned components. Preferably, however, a PEO-PPO-PEO triblock copolymer as described herein is incorporated into the curing component because, compared to epoxy resin components containing a PEO-PPO-PEO triblock copolymer as described herein, improved storage stabilities result, with increased storage stability in this case manifesting in a significantly reduced crystallization rate and, moreover, in reduced yellowing.

Accordingly, according to some preferred embodiments, the at least one PEO-PPO-PEO triblock copolymer is contained in the resin composition according to the invention as a constituent of the curing component.

Resin compositions which comprise a PEO-PPO-PEO triblock copolymer as defined herein can be cured to form articles which have a particularly advantageous combination of optical and mechanical properties. Correspondingly cured products are characterized by a high toughness (K1c value ≥0.8) and high glass transition temperatures (DSC midpoint 200° C.) and are both transparent and colorless at the same time.

According to the invention, the resin compositions furthermore comprise at least one epoxy resin component. A suitable epoxy resin component comprises one or more epoxide compounds, as described below.

In the context of the present invention, the epoxy resin may comprise epoxide group-containing monomers, prepolymers and polymers and mixtures thereof, and is also referred to in the following as epoxide or epoxide group-containing resin. Suitable epoxide group-containing resins are in particular resins having 1 to 10, preferably 2 to 10 epoxide groups per molecule. “Epoxide groups” as used herein refers to 1,2-epoxide groups (oxiranes).

The epoxy resins usable herein may vary and include conventional and commercially available epoxy resins, each of which can be used individually or in a combination of two or more different epoxy resins. In selecting the epoxy resins, not only the properties of the final product but also the properties of the epoxy resin, such as the viscosity and other properties which affect processability, are important.

The epoxide equivalent of the polyepoxides can vary between 75 and 50,000, preferably between 170 and 5,000. In principle, the polyepoxides can be saturated, unsaturated, cyclic or acyclic, aliphatic, cycloaliphatic, aromatic or heterocyclic polyepoxide compounds.

According to some embodiments, the at least one epoxy resin component comprises a cycloaliphatic epoxy resin.

Examples of suitable cycloaliphatic epoxides are compounds which have a saturated hydrocarbon ring having an epoxide oxygen atom bonded to two adjacent carbon atoms of the carbon ring, as shown in the following formula (I):

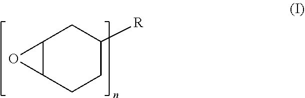

where R is a linking group and n is an integer from 2 to 10, preferably from 2 to 4, and even more preferably from 2 to 3. These are di- or polyepoxides when n is 2 or more. Such cycloaliphatic epoxy resins can have an epoxide equivalent weight of approximately 95 to 250, in particular from 100 to 150. Mixtures of mono-, di- and/or polyepoxides can be used.

Further examples of suitable cycloaliphatic epoxides are in particular the epoxides of cycloaliphatic esters of dicarboxylic acids such as bis-(3,4-epoxycyclohexylmethyl) oxalate, bis-(3,4-epoxy-cyclohexylmethyl) adipate, bis-(3,4-epoxy-6-methylcyclohexylmethyl) adipate, and bis-(3,4-epoxycyclohexylmethyl) pimelate. Further suitable diepoxides of cycloaliphatic esters are described, for example, in U.S. Pat. No. 2,750,395.

Further suitable cycloaliphatic epoxides are, for example, 3,4-epoxycyclohexylmethyl-3,4-epoxycyclohexane carboxylate, bis-(3,4-epoxycyclohexyl) adipate, and 3,4-epoxy-1-methylcyclohexylmethyl-3,4-epoxy-1-methylcyclohexane carboxylate. Further suitable cycloaliphatic epoxides are described, for example, in U.S. Pat. No. 2,890,194.

According to some embodiments, the at least one epoxy resin component comprises an epoxy compound selected from the group consisting of bis-(3,4-epoxycyclohexylmethyl) oxalate, bis-(3,4-epoxy-cyclohexylmethyl) adipate, bis-(3,4-epoxy-6-methylcyclohexylmethyl) adipate, bis-(3,4-epoxycyclohexylmethyl) pimelate, 3,4-epoxycyclohexylmethyl-3,4-epoxycyclohexane carboxylate, bis-(3,4-epoxycyclohexyl) adipate, 3,4-epoxy-1-methylcyclohexylmethyl-3,4-epoxy-1-methylcyclohexane carboxylate, and mixtures thereof.

Other polyepoxides suitable for use in the resin composition according to the invention include, for example, polyglycidyl ethers produced by reacting epichlorohydrin or epibromohydrin with a polyphenol in the presence of an alkali. Polyphenols suitable for this are, for example, resorcinol, pyrocatechol, hydroquinone, bisphenol A (bis-(4-hydroxy-phenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane and 1,5-hydroxynaphthaline. Other polyphenols which are suitable as the basis for polyglycidyl ethers are the known condensation products of phenol and formaldehyde or acetaldehyde of the novolac resin type.

Other polyepoxides which are in principle suitable are the polyglycidyl ethers of polyalcohols or diamines. These polyglycidyl ethers are derived from polyalcohols such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides are polyglycidyl esters of polycarboxylic acids, for example reactions of glycidol or epichlorohydrin with aliphatic or aromatic polycarboxylic acids such as oxalic acid, succinic acid, glutaric acid, terephthalic acid or dimer fatty acid.

Other suitable epoxy resins are known in the prior art and can be found, for example, in Lee H. & Neville, K., Handbook of Epoxy Resins, McGraw-Hill Book Company, 1982 reprint.

Other epoxides are derived from the epoxidation products of olefinically unsaturated cycloaliphatic compounds or from native oils and fats.

Depending on the intended use, it may be preferable for the composition to additionally contain a flexibilizing resin. This may also be an epoxy resin. The adducts, which are known per se, of carboxyl-terminated butadiene acrylonitrile copolymers (CTBN) and liquid epoxy resins based on the diglycidyl ether of bisphenol A can be used as flexibilizing epoxy resins. Specific examples are the reaction products of Hycar CTBN 1300 X8, 1300 X13 or 1300 X15 from B.F. Goodrich with liquid epoxy resins. Furthermore, the reaction products of amino-terminated polyalkylene glycols (Jeffamine) can also be used with an excess of liquid polyepoxides. In principle, reaction products of mercapto-functional prepolymers or liquid Thiokol polymers can also be used according to the invention with an excess of polyepoxides as flexibilizing epoxy resins. However, the reaction products of polymeric fatty acids, in particular dimer fatty acid, with epichlorohydrin, glycidol or in particular diglycidyl ethers of bisphenol A (DGBA) are very particularly preferred.

The resin compositions according to the invention furthermore comprise at least one curing component.

According to some embodiments, the at least one curing component comprises at least one anhydride curing agent.

Examples of suitable anhydride-based curing agents are norbornene-based dicarboxylic acid anhydrides. Suitable norbornene-based dicarboxylic acid anhydrides are shown by the following formula (II):

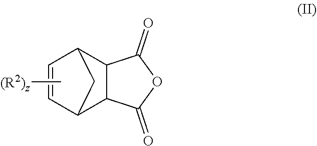

where each R independently represents hydrocarbyl, halogen, or inertly substituted hydrocarbyl; z is an integer from 0 to 8, preferably an integer from 0 to 2, in particular from 0 to 1; and R², if present, represents an alkyl group, preferably a methyl group. As used herein, the term “inertly substituted” means that the substituent does not adversely affect the ability of the anhydride group to react with and cure the epoxy resin. In cases where z is 1 or more, preferably at least one R² group is bonded to the carbon atom in position 5. In norbornene-based dicarboxylic acid anhydrides, the dicarboxylic acid anhydride group can be in the exo or endo conformation. In the context of this invention, the two isomers and mixtures of the two isomers are suitable in principle. Preferred examples of a norbornene-based dicarboxylic acid anhydride as described herein are bicyclo[2.2.1]-5-heptene-2,3-dicarboxylic acid anhydride, i.e. an anhydride of the aforementioned structure, where z is 0, and bicyclo[2.2.1]-methylhept-5-ene-2,3-dicarboxylic acid anhydride, i.e. an anhydride of the aforementioned structure, where R² is methyl and z is 1, the methyl group preferably being bonded to the carbon atom in position 5. According to some embodiments, the at least one curing component of the resin compositions described herein comprises at least one anhydride curing agent, the at least one anhydride curing agent being selected from bicyclo[2.2.1]-5-heptene-2,3-dicarboxylic acid anhydride, bicyclo[2.2.1]-methylhept-5-ene-2,3-dicarboxylic acid anhydride and mixtures thereof. Other suitable anhydride-based curing agents are saturated norbornene-based dicarboxylic acid anhydrides. These are derived from the structures mentioned above, the double bond in the norbornene skeleton being hydrogenated.

Further anhydride curing agents are aliphatic anhydrides, such as, for example, hexahydrophthalic anhydride, tetrahydrophthalic anhydride, methyltetrahydrophthalic anhydride, methylhexahydrophthalic anhydride and mixtures of the above; as well as aromatic anhydrides such as phthalic anhydride, trimellitic anhydride and mixtures thereof. Particularly suitable anhydride curing agents are hexahydrophthalic anhydride, methylhexahydrophthalic anhydride and mixtures thereof. Further suitable anhydride curing agents are copolymers of styrene and maleic anhydride and other anhydrides which are copolymerizable with styrene.

According to preferred embodiments, the at least one curing component of the resin compositions described herein comprises at least one anhydride curing agent, the at least one anhydride curing agent being selected from hexahydrophthalic anhydride, methylhexahydrophthalic anhydride and mixtures thereof.

Furthermore, guanidines, substituted guanidines, substituted ureas, melamine resins, guanamine derivatives, cyclic tertiary amines, aromatic amines and/or mixtures thereof can be used as thermally activatable or latent curing agents. In this case, the curing agents can be stoichiometrically involved in the curing reaction. However, they may also have a catalytic effect. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and more particularly cyanoguanidine (dicyandiamide). Examples of suitable guanamine derivatives include alkylated benzoguanamine resins, benzoguanamine resins or methoxymethyl-ethoxymethylbenzoguanamine. For monocomponent, heat-curing shaped bodies, the selection criterion is the low solubility of these substances at room temperature in the resin system, such that solid, finely ground curing agents are preferred in this case. Dicyandiamide is particularly suitable. Good storage stability of the heat-curable shaped bodies is thus ensured.

In addition to or instead of the aforementioned curing agents, substituted ureas which have a catalytic effect can be used. These are in particular p-chlorophenyl-N,N-dimethylurea (monuron), 3-phenyl-1,1-dimethylurea (fenuron) or 3,4-dichlorophenyl-N,N-dimethylurea (diuron). In principle, it is also possible to use tertiary acrylic or alkyl amines which have a catalytic effect, for example benzyldimethylamine, tris(dimethylamino)phenol, piperidine or piperidine derivatives. However, these are often too soluble in the adhesive system, such that the monocomponent system is not suitably storage stable. Furthermore, various, preferably solid imidazole derivatives can be used as accelerators which have a catalytic effect. Examples which may be mentioned include 2-ethyl-2-methylimidazole, N-butylimidazole, benzimidazole and N—C₁₋₁₂-alkylimidazoles or N-arylimidazoles. Particularly preferred is the use of a combination of a curing agent and an accelerator in the form of so-called accelerated dicyandiamides in a finely ground form. This means that it is superfluous to separately add accelerators which have a catalytic effect to the epoxide curing system.

Furthermore, strong Lewis acids, such as onium ions, in particular phosphonium or sulfonium derivatives, can be used for the catalysis of the anhydride curing. According to some preferred embodiments, the at least one curing component of the resin compositions described herein comprises at least one catalyst, the at least one catalyst being selected from onium salts, in particular from phosphonium and sulfonium salts, preferably from phosphonium salts.

In a preferred embodiment, the resin composition according to the invention contains, in particular in the curing component, at least one quaternary phosphonium compound as a catalyst.

Suitable phosphonium compounds are represented in the context of the present invention by the following formula (III):

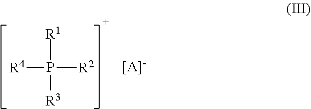

where R¹-R⁴ are each selected independently of one another from hydrogen, halogen, linear or branched C1-C20 alkyl, linear or branched C2-C20 alkenyl, linear or branched C2-C20 alkynyl, C3-C8 cycloalkyl, and C6-C10 aryl, where the aforementioned organic functional groups can each be substituted or unsubstituted, the substituents each being independently selected from C1-C6 alkyl, C2-C6 alkenyl, C2-C6 alkynyl and halogen; and A represents a halogen atom. The functional groups R¹-R⁴ are preferably each selected independently of one another from linear C1-C12 alkylenes, such as methyl, ethyl, n-propyl, n-butyl, n-pentyl, n-hexyl, n-heptyl, n-octyl, n-nonyl, n-decyl, n-undecyl and n-dodecyl.

In some embodiments, the counterion [A]⁻ in the above formula can also be a quaternary boron compound, such as tetraphenylborate, an alkyl phosphate, an alkyl phosphinate, trifluoromethylsulfonylamide, dicyanamide, an alkanoate and a tosylate.

In preferred embodiments, the at least one phosphonium compound is trihexyl(tetradecyl)phosphonium chloride and/or tributylethylphosphonium diethyl phosphate.

According to some embodiments, suitable phosphonium compounds can also be in the form of ionic liquids.

The resin compositions according to the invention contain the at least one quaternary phosphonium compound, preferably in an amount in the range of from 0.1-5 wt. %, preferably in an amount in the range of from 0.4-1.5 wt. %, in each case based on the total weight of the resin composition.

The compositions according to the invention can also be formulated as two-component compositions in which the two reaction components are only mixed with one another shortly before application, curing then taking place at room temperature or at a moderately elevated temperature. The reaction components known per se for two-component epoxy compositions can be used as the second reaction component, for example di- or polyamines, amino-terminated polyalkylene glycols (e.g. Jeffamine, amino-poly-THF) or polyaminoamides. Further reactive partners can be mercapto-functional prepolymers, such as liquid Thiokol polymers, and the epoxy compositions according to the invention can also preferably be cured in 2K formulations with carboxylic acid anhydrides as the second reaction component.

The amount of curing agent depends on a number of factors, but concentrations in the range of from 0.5 to 60 wt. %, based on the total weight of the formulation, are common. In the case of an anhydride-based curing agent, the amount of anhydride is preferably selected in a molar ratio to the epoxide of 2:1 to 1:2, preferably 1.1:1 to 1:1.1, and is particularly preferably equimolar.

The present invention further relates to a method for producing a cured composition, comprising the steps of (1) providing a resin composition as described above and (2) curing the resin composition to thereby obtain a cured composition.

Correspondingly cured compositions have an increased mechanical stability, in particular an increased impact toughness, without lowering the glass transition temperature, such that the compositions obtained can be exposed to elevated temperatures during manufacture and the intended use thereof. Said compositions are therefore particularly suitable for the production of fiber-reinforced plastics shaped parts, such as automobile parts.

“Providing”, as used herein, refers to mixing the constituents of the resin composition in any sequence. It can be advantageous, for example, to first combine two or more constituents and optionally mix said constituents to form a heterogeneous or homogeneous mixture before the remaining constituents are added. Thus, for example, the at least one epoxy resin component can first be mixed with optionally further constituents and then, for example shortly before curing, the at least one curing component can be added and mixed into the other constituents which have already been mixed. Between the various combining and mixing steps, it can be advantageous to cool the reaction mixture to room temperature. In another embodiment, it can be advantageous to heat the reaction mixture between the various combination and mixing steps in order to improve the solubility.

In general, the individual constituents of the resin composition can be used per se or as a solution in a solvent, for example an organic solvent or a mixture of organic solvents. For this purpose, any known solvent which is suitable for the purpose according to the invention can be used. The solvent can be a high-boiling organic solvent, for example. The solvent can be selected from the group consisting of petroleum, benzene, toluene, xylene, ethyl benzene and mixtures thereof.

The resin composition described herein can be combined with other constituents known in the art in the form of an adhesive composition or an injection resin.

Adhesive compositions or injection resins of this kind can contain a large number of other components, all of which are known to a person skilled in the art, including, but not limited to, frequently used auxiliaries and additives, for example fillers, plasticizers, reactive and/or nonreactive diluents, mobile solvents, coupling agents (e.g., silanes), release agents, adhesion promoters, wetting agents, adhesion agents, flame retardants, wetting agents, thixotropic agents and/or rheological auxiliaries (e.g. pyrogenic silicic acid), aging and/or corrosion inhibitors, stabilizers and/or dyes. Depending on the requirements of the adhesive or the injection resin and the use thereof and with respect to the production, flexibility, strength and adhesion to substrates, the auxiliaries and additives are incorporated into the composition in different amounts.

Suitable fillers include the various chalks, quartz powder, alumina, dolomite, carbon fibers, glass fibers, polymer fibers, titanium dioxide, silica glass, activated carbon, talc, calcium oxide, calcium magnesium carbonates, barium sulfate, and in particular silicate-like fillers of the aluminum-magnesium-calcium silicate type, such as wollastonite and chlorite. Typically, the compositions contain from approximately 0.5 to approximately 10 wt. % fillers.

In preferred embodiments, the compositions of the invention do not contain plasticizers, or contain less than 0.1 wt. % of plasticizers, since these tend to lower the T_{g}.

In various embodiments of the invention, depending on the desired use, the resin composition is applied to a substrate, for example when being used as an adhesive, or filled into a die when being used as a molding compound for producing plastics parts. In preferred embodiments, the method is a transfer molding (RTM) method and the resin composition is a reactive injection resin. “Reactive,” as used in this context, refers to the fact that the injection resin is chemically crosslinkable. In the RTM method, providing the resin composition, i.e. step (1) of the described method, can comprise filling, in particular injecting, the injection resin into a die. In the production of fiber-reinforced plastics parts for which the described method and reaction mixtures are particularly suitable, fibers or semi-finished fiber products (prewovens/preforms) can be placed into the die before injection into said die. Materials known in the prior art for this application, in particular carbon fibers, can be used as the fibers and/or semi-finished fiber products.

In various embodiments, resin compositions of this kind are adhesive compositions or injection resins. The injection resins are preferably pumpable and in particular suitable for transfer molding (RTM method). In various embodiments, the reaction mixture therefore has a viscosity of <100 mPas at a temperature of 100° C., i.e. a typical infusion temperature.

In one embodiment, the invention therefore also relates to the molded parts which can be obtained in the RTM method by means of the resin systems according to the invention. RTM methods in which the described resin systems can be used are known per se in the prior art and can be readily adapted by a person skilled in the art such that the reaction mixture according to the invention can be used.

The open times of the resin compositions, as described herein, are preferably greater than 90 seconds and are preferably in the range of from 2 to 5 minutes, in particular are approximately 3 minutes. “Approximately,” as used herein in relation to a numerical value, means the numerical value ±10%.

Depending on the type of epoxides and curing agents used and the use of the cured composition, the resin composition in step (2) of the method according to the invention can be cured at different reaction temperatures. The curing temperature can thus be between 70° C. and 280° C.

The curing process can generally be carried out at an elevated temperature, i.e. >25° C. The resins are preferably cured between 80° C. and 280° C. and more preferably between 100° C. and 240° C. The duration of the curing process likewise depends on the resins to be cured and on the catalyst composition and can be between 0.01 hours and 10 hours. The curing cycle preferably lasts a few minutes, i.e. in particular 1 to 15 minutes. The curing process can also take place in one or more steps.

In some embodiments, the resin composition described herein is cured in a one-step method at a temperature of between 80° C. and 240° C., preferably between 100° C. and 200° C., and more preferably between 120° C. and 180° C., for 0.01 hours to 10 hours, preferably for 0.1 hour to 5 hours, more preferably for 1 hour.

In alternative embodiments, a resin composition as described herein can be cured in a multi-step method. Such a multi-step method includes a first step of pre-curing, the resin composition being pre-cured at a temperature of between 70° C. and 150° C., preferably 100° C. and 140° C., and more preferably at 120° C., for 0.01 hours to 3 hours, preferably for 0.1 hours to 2 hours, more preferably for 0.25 hours, and is then post-cured in a second step. This second step of post-curing can comprise one or more sub-steps such that the pre-cured resin composition is post-cured at least once, preferably at least twice, and more preferably at least three times, in each case at a temperature of between 110° C. and 260° C., preferably 130° C. and 190° C., and more preferably at 180° C., in each case for 0.1 hours to 3 hours, preferably for 0.5 hours to 2 hours, and more preferably for 1 hour. For example, such a second curing step can comprise post-curing the pre-cured resin composition at a temperature of between 130° C. and 230° C., preferably 150° C. and 220° C., and more preferably at 180° C., for 0.1 hours to 3 hours, preferably for 0.5 hours to 2 hours, and more preferably for 1 hour; then at a temperature of between 150° C. and 250° C., preferably between 170° C. and 230° C., and more preferably at 190° C., for 0.1 hours to 3 hours, preferably for 0.5 hours to 2 hours, and more preferably for 1 hour; and then at a temperature of between 180° C. and 260° C., preferably 200° C. and 250° C., and more preferably at 220° C., for 0.1 hours to 3 hours, preferably for 0.5 hours to 2 hours, and more preferably for 1 hour.

The resins cured by means of the catalyst systems and method described herein preferably have a critical stress intensity factor K1c of >0.8, preferably at least 0.9, more preferably >0.95 and most preferably >1. In various embodiments, the glass transition temperature of the cured resins is in the range of more than 180° C., in particular more than 190° C., and typically in the range of up to 220° C. In some embodiments, cured systems have a glass transition temperature of 200° C. (DSC midpoint). The modulus of elasticity of the cured resins is preferably at least 2,000 N/mm², more preferably at least 2,100 N/mm², and typically in the range of from 2,200 to 5,000 N/mm².

Moreover, the present invention relates to the cured composition which can be obtained according to the method described herein. Depending on the method, said composition can be present as a molded part, in particular as a fiber-reinforced plastics molded part. Such molded parts are preferably used in automobile construction or aerospace.

The cured compositions are thus particularly suitable as a matrix resin for fiber composite materials. These can be used in various methods of application, for example in the resin transfer molding method (RTM method) or in the infusion method.

Known high-strength fiber materials are suitable as fiber constituents of the fiber composite materials. These can, for example, consist of glass fibers; synthetic fibers such as polyester fibers, polyethylene fibers, polypropylene fibers, polyamide fibers, polyimide fibers or aramid fibers; carbon fibers; boron fibers; oxide or non-oxide ceramic fibers such as aluminum oxide/silicon dioxide fibers, silicon carbide fibers; metal fibers, for example made of steel or aluminum; or of natural fibers such as flax, hemp or jute. Said fibers can be incorporated in the form of mats, woven fabrics, knitted fabrics, non-woven fabrics, fibrous webs or rovings. Two or more of these fiber materials may also be used as a mixture. Short cut fibers can be selected, but synthetic long fibers are preferably used, in particular woven and non-woven fabrics. Such high-strength fibers, non-woven fabrics, woven fabrics and rovings are known to a person skilled in the art.

In particular, the fiber composite material should contain fibers in a proportion by volume of more than 40 vol. %, preferably more than 50 vol. %, particularly preferably between 50 and 70 vol. %, based on the total fiber composite material, in order to achieve particularly good mechanical properties. In the case of carbon fibers, the proportion by volume is determined according to standard DIN EN 2564:1998-08 and in the case of glass fibers, it is determined according to standard DIN EN ISO 1172:1998-12.

A fiber composite material of this kind is suitable in particular as an automobile part. Compared with steel, such fiber composite materials have several advantages, i.e. they are lighter in weight, are characterized by improved crash resistance and are also more durable.

Moreover, it goes without saying that all embodiments that have been disclosed above in connection with the described method can also be used in the same manner in the described resin systems and cured compositions, and vice versa.

### EXAMPLES

The material properties of resin compositions consisting of an epoxide component (110 g of a cycloaliphatic epoxide (epoxide weight 130 g/mol; viscosity 240 mPas at room temperature) plus 0.15 g of a multifunctional fatty acid ester) and a curing component (140 g methyl hexahydrophthalic anhydride plus 4.4 g tributyl(ethyl)phosphonium diethyl phosphate) with regard to the composition and amount of PEO-PPO-PEO-based block copolymers are listed below in table form. For the production of corresponding pure resin panels, the listed raw materials of the epoxy resin component were first weighed into a speed mixer and mixed for 5 minutes at 800 rpm in a vacuum. The raw materials of the curing component were then weighed and mixed again for 5 minutes at 800 rpm in a vacuum. The mixtures obtained in this way were then poured into correspondingly prepared stainless steel molds preheated to 120° C. in the autoclave, and first cured in the autoclave at 120° C. for 30 minutes and then at 180° C. for one hour.

| | | | T_{g} | | |
|---|---|---|---|---|---|
| | | Additive | (DSC) | | Visual |
| No. | Additive | [wt. %] | [° C.] | K1c | appearance |
| 1 | Fortegra 100^{a)} | 10.54 | 206 | 0.80 | clear, colorless |
| 2 | Pluronic PE 10500^{b)} | 10.54 | 203 | 0.84 | clear, yellow- |
| | | | | | brown |
| 3 | Pluronic PE 10500 | 15.02 | 186 | 0.85 | clear, yellow- |
| | | | | | brown |
| 4 | Pluronic L64^{c)} | 10.58 | 195 | 0.52 | clear, colorless |
| 5 | Pluronic L121^{d)} | 10.58 | 207.5 | 0.75 | slightly cloudy |
| 6 | Pluronic F108^{e)} | 10.58 | 222 | 1.05 | clear, slightly |
| | | | | | yellowish |
| 7 | Pluronic F127^{f)} | 10.58 | 205.6 | 0.97 | clear, slightly |
| | | | | | yellowish |

^{a)}PPO-PBO diblock copolymer;
^{b)}PEO-PPO-PEO triblock copolymer, MW PPO = 3,250, MW PEO = 3,250, total MW = 6,500;
^{c)}PEO-PPO-PEO triblock copolymer, MW PPO = 1,750, MW PEO = 1,167, total MW = 2,917;
^{d)}PEO-PPO-PEO triblock copolymer, MW PPO = 4,000, MW PEO = 444, total MW = 4,444;
^{e)}PEO-PPO-PEO triblock copolymer, MW PPO = 3,250, MW PEO = 13,000, total MW = 16,250;
^{f)}PEO-PPO-PEO triblock copolymer, MW PPO = 4,000, MW PEO = 9,333, total MW = 13,333.

1. A resin composition comprising at least one epoxy resin component and at least one curing component, wherein the resin composition further comprises at least one PEO-PPO-PEO triblock copolymer.

2. The resin composition according to claim 1, wherein the at least one PEO-PPO-PEO triblock copolymer in the resin composition is present in a range of 5-20 wt. %, based in each case on total weight of the resin composition.

3. The resin composition according to claim 1, wherein the at least one PEO-PPO-PEO triblock copolymer has a molecular weight of >6,000.

4. The resin composition according to claim 1, wherein the at least one PEO-PPO-PEO triblock copolymer has a molar mass fraction of PEO block polymers of 50%-90%.

5. The resin composition according to claim 1, wherein the at least one epoxy resin component is an epoxy compound selected from the group consisting of bis-(3,4-epoxycyclohexylmethyl) oxalate, bis-(3,4-epoxy-cyclohexylmethyl) adipate, bis-(3,4-epoxy-6-methylcyclohexylmethyl) adipate, bis-(3,4-epoxycyclohexylmethyl) pimelate, 3,4-epoxycyclohexylmethyl-3,4-epoxycyclohexane carboxylate, bis-(3,4-epoxycyclohexyl) adipate, 3,4-epoxy-1-methylcyclohexylmethyl-3,4-epoxy-1-methylcyclohexane carboxylate, and mixtures thereof.

6. The resin composition according to claim 1, wherein the at least one curing component comprises at least one anhydride curing agent.

7. The resin composition according to claim 6, wherein the at least one anhydride curing agent is selected from hexahydrophthalic anhydride, methylhexahydrophthalic anhydride and mixtures thereof.

8. A method for producing a cured composition, comprising steps of (1) providing a resin composition according to claim 1; and (2) curing the resin composition to obtain a cured composition.

9. The method according to claim 8, wherein the method is a transfer molding (RTM) method and the resin composition is a reactive injection resin.

10. The method according to claim 9, wherein step (1) comprises injecting the resin composition into a die into which fibers or semi-finished fiber products are inserted, said semi-finished fiber products being selected from prewovens and/or preforms.

11. The method according to claim 8, wherein
(a) the resin composition in step (2) is cured at a temperature of between 80° C. and 240° C. for 0.01 to 10 hours; or
(b) the resin composition in step (2) is first cured at a temperature of between 70° C. and 150° C. for 0.1 hours to 3 hours; and then is cured at least twice at a temperature of between 110° C. and 260° C., for 0.1 hours to 3 hours in each case.

12. A cured composition made according to the method of claim 8.

13. The cured composition according to claim 12, wherein the K1c value of the cured composition is at least 0.8.

14. The cured composition according to claim 12, wherein the cured composition has a glass transition temperature T_{g}≥180° C.

15. The cured composition according to claim 12, wherein the cured composition is a molded part, optionally a fiber-reinforced molded part.
